(19) United States
(12) Patent Application Publication
(10) Pub. No.: US 2002/0117188 A1
(43) Pub. Date: Aug. 29, 2002

(54) Wafer presence sensor for detecting quartz wafers

(76) Inventors: Vladimir Galburt, Campbell, CA (US); Michael Sugarman, San Francisco, CA (US); Manoocher Birang, Los Gatos, CA (US)

Correspondence Address: PATENT COUNSEL, APPLIED MATERIALS, INC., Legal Affairs Department, P.O. Box 450A, Santa Clara, CA, 95052, US

(21) Appl. No.: 09/797,218

(22) Filed: Feb. 28, 2001

(51) Int. Cl. B08B 3/04; B08B 13/00

(52) U.S. Cl. 134/18; 134/26; 134/83; 134/113

(57) ABSTRACT

An acoustic transmitter and an acoustic receiver are positioned to define a path for travel of an acoustic signal from the acoustic transmitter to the acoustic receiver. A substrate is positioned in the path so as to interrupt the acoustic signal. The acoustic receiver detects interruption of the acoustic signal. The acoustic signal path may be provided above a chamber in which the substrate is processed, such as by cleaning or drying the substrate. The acoustic signal path may be arranged at an angle relative to a plane defined by raising and lowering the substrate relative to the processing chamber. The angling of the acoustic signal path prevents interference with the signal paths provided with respect to other processing modules arranged in a linear array.

### FIELD OF THE INVENTION

The present invention is concerned with substrate fabrication equipment, and more particularly is directed to sensors for use with such equipment.

### BACKGROUND OF THE INVENTION

Manufacturing of substrates such as semiconductor wafers, glass substrates or flat panel displays often involves a sequence of steps performed on the substrates, each process being carried on in a respective module or chamber of the processing equipment. Frequently, automatic devices such as robots are used to transport the wafers from one processing chamber to another.

Although transportation of wafers by robot is very reliable, it is not completely free of error. Occasionally, robots drop wafers or fail to receive them as scheduled. In order to minimize disruption of manufacturing processes, it is known to use automatic detection equipment to confirm that wafers are in the right place at the right time.

According to conventional practice, optical sensing equipment is used. Conventional optical sensors include an optical transmitter and an optical receiver which are positioned to define an optical signal path. When a wafer (or other object) blocks the optical signal path at an appropriate time, it is inferred that a wafer is present. If the optical path is not obstructed at a time when it is expected that a wafer is to be present in the optical signal path, then appropriate steps are taken, such as interrupting fabrication processing, setting off an alarm, and so forth.

The present inventors have recognized that conventional optical sensing practices used in connection with semiconductor fabrication are not always as reliable as may be desired. For example, optical sensing may not be suitable for reliably detecting transparent wafers such as quartz wafers, because a transparent wafer may fail to block the optical signal path between the optical transmitter and the optical receiver. That is, the light transmitted by an optical transmitter may pass directly through a quartz wafer, to reach the receiver without significant disruption, so that the optical sensor is unable to detect the presence of a quartz wafer.

Further, when it is attempted to employ optical sensing in a wet environment such as a megasonic cleaning tank or a scrubber tank, even with respect to opaque wafers the presence of liquid, or even stray drops of liquid, may interfere with reliable wafer detection.

Accordingly, improvements are needed in detection of wafers in connection with substrate fabrication processes.

### SUMMARY OF THE INVENTION

An inventive method of detecting the presence of a substrate includes positioning an acoustic transmitter and an acoustic receiver to define a path for travel of an acoustic signal from the acoustic transmitter to the acoustic receiver. The inventive method further includes positioning a substrate in the path so as to interrupt the acoustic signal, and using the acoustic receiver to detect interruption of the acoustic signal.

In one aspect, the acoustic transmitter and the acoustic receiver may be positioned above a chamber adapted to process the substrate. The process performed in the chamber may be cleaning and/or drying the substrate. The path defined by the acoustic transmitter and the acoustic receiver may form an acute angle with a plane in which the substrate is raised from the chamber in a vertical orientation.

According to another aspect of the invention, an inventive wafer detector apparatus includes a linear array of chambers adapted to clean and/or dry substrates. The inventive apparatus further includes a transport mechanism adapted to lower the substrates into and raise the substrates from the chambers. The transport mechanism raises and lowers the substrates while holding the substrates in a vertical orientation, and the raising and lowering of each respective substrate with respect to a chamber defines a respective vertical plane. The inventive apparatus further includes a plurality of transmitter/receiver pairs each adapted to define respective signal paths. Each of the signal paths intersects a respective one of the vertical planes at an acute angle. In this aspect acoustic or optical sensors may be employed.

When using an acoustic sensor instead of an optical sensor, the present invention is able to reliably detect even transparent substrates such as quartz wafers. Furthermore, an aspect of the present invention places the detection signal path above a chamber such as a megasonic cleaning chamber, so that detection proceeds without interference from liquid in the cleaning chamber. Moreover, by providing multiple signal paths at angles relative to a vertical plane of transport of substrates, the multiple detection signal paths can be arranged so as not to interfere with each other, thereby promoting reliable detection of wafers.

Further features and advantages of the present invention will become more fully apparent from the following detailed description of the preferred embodiments, the appended claims and the accompanying drawings.

### BRIEF DESCRIPTION OF THE DRAWINGS

FIG. 1 is a schematic side elevational view of a wafer cleaning system in which the present invention is applied; and

FIG. 2 is a partial schematic plan view of the cleaning system of FIG. 1.

### DETAILED DESCRIPTION OF THE PREFERRED EMBODIMENTS

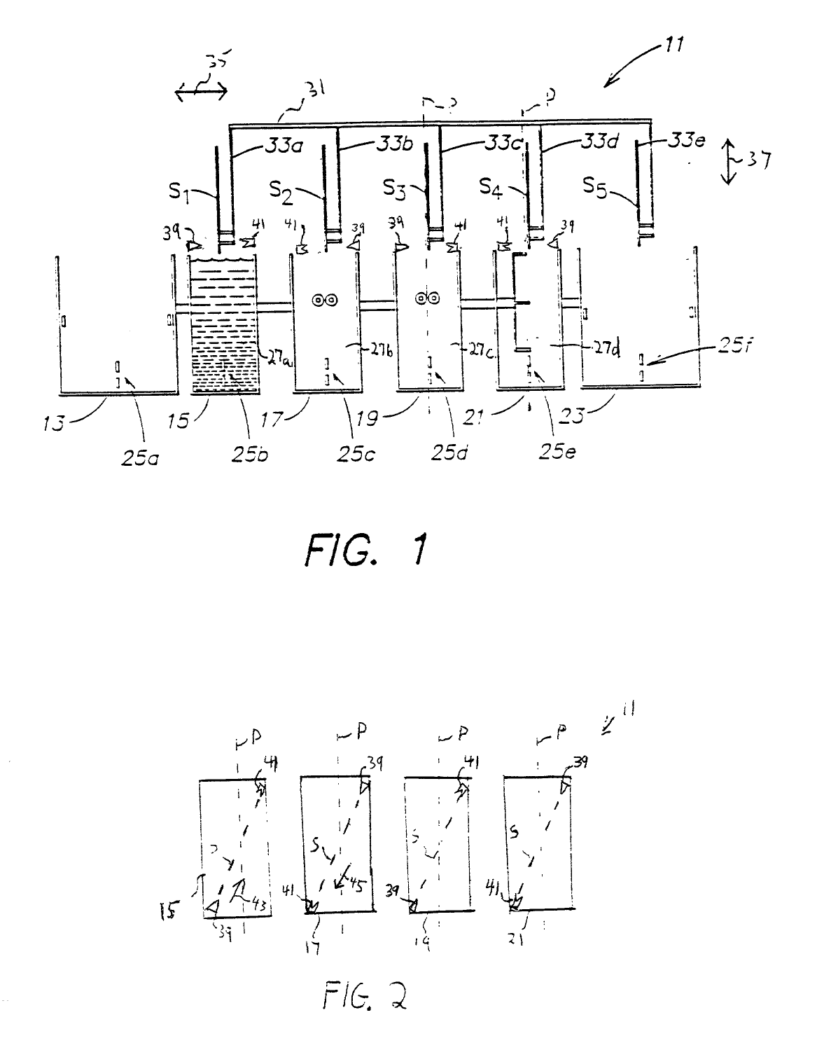

FIG. 1 is a schematic side elevational view of a wafer cleaning system in which the present invention is applied; FIG. 2 is a partial schematic plan view of the same wafer cleaning system.

In the drawings, reference numeral 11 generally refers to the wafer cleaning system. This system may be of the type disclosed in U.S. patent application Ser. No. 09/558,815, filed Apr. 26, 2000, of which the entire disclosure is hereby incorporated herein by reference. The wafer cleaning system includes a load module 13, a megasonic cleaner 15, a first scrubber 17, a second scrubber 19, a spin-rinse-dryer 21, and an unload module 23. It will be observed from FIG. 2 that the modules 15-21 are arranged to form a linear array. The modules 13-23 have wafer supports 25a-f, respectively, for supporting a wafer in a vertical orientation. Each of the modules 15-21 respectively includes a chamber 27a-27d in which processing of the wafer (i.e., cleaning or drying) is performed.

The cleaning system 11 also includes a wafer transport mechanism 31 having a plurality of wafer handlers 33a-e. Wafers S₁-S₅ are shown respectively held in a vertical orientation by the wafer handlers 33a-e. The transport mechanism 31, as described in the above-referenced '815 patent application, may be a walking beam type robot that is movable horizontally, as indicated by double headed arrow mark 35, and also is movable vertically, as indicated by double headed arrow mark 37. By its horizontal movement, the transport mechanism 31 transports the wafers in a horizontal direction above the modules 13-23 from one module to the next. By its vertical movement, the transport mechanism 31 lowers wafers into or raises wafers from the respective chambers of the modules 15-21. Dashed lines P in the drawings indicate vertical planes defined by the lowering and the raising of the wafers into and from the chambers of the modules 15-21. (In FIG. 1, to simplify the drawing, vertical plane lines P are drawn only with respect to modules 19 and 21; it will be recognized that similar lines can be drawn with respect to modules 15 and 17 as well.)

Installed above each of the modules 15-21 is a respective acoustic sensor constituted by an acoustic transmitter 39 and an acoustic receiver 41. As seen from FIG. 2, each transmitter/receiver pair defines a signal path S by which an acoustic signal travels from the transmitter to the receiver. As shown in FIG. 2, with respect to each of the modules 15-21, the respective acoustic signal path S intersects the respective vertical plane P at an acute angle. It will also be observed that the signal paths S are substantially parallel to each other. Moreover, the signal paths S are arranged in alternating fashion such that, in association with modules 15 and 19, the acoustic signal is transmitted in a direction indicated by arrow 43, whereas in association with modules 17 and 21, the acoustic signal is transmitted in an opposite direction indicated by arrow 45. In other words for adjacent modules the acoustic signals are transmitted in opposite directions.

The acoustic transmitter/receiver pairs may be constituted by conventional devices. For example, the model T186UE emitter and the model T18VN6UR receiver, available from Banner Engineering Corporation, Minneapolis, Minn., may be employed as the transmitter 39 and the receiver 41, respectively.

The Banner transmitter/receiver pair provides a maximum detection distance of about 24 inches. This limited detection distance, together with the arrangement of signal paths S as shown in FIG. 2, helps to prevent interference among the various acoustic sensors. That is, with the arrangement shown in FIG. 2, it is unlikely that the receiver of one sensor pair will receive a signal transmitted from the transmitter of another sensor pair.

Although not shown in the drawings, it should be understood that the wafer cleaning system 11 also includes suitable control signal circuitry to control operation of the transport mechanism 31 and the modules 13-3, and to receive outputs from the acoustic receivers 41. Suitable control signal and sensor output signal connections are also provided, although the same are not shown in the drawings.

In operation, the transport mechanism 31 transports wafers S₁-S₅. from one module to another, and the wafers are processed (i.e., cleaned or dried) in the modules. The transporting of the wafers involves both horizontal movements of the wafers and vertical movements of the wafers. At certain times before, during and/or after vertical movement of the wafers by the transport mechanism 31, the wafers interrupt the signal paths S defined by the acoustic transmitter-receiver pairs. The receivers 41 detect the interruption of the signal paths S and provide outputs indicative of the interruption of the signal paths, thereby confirming that the wafers are present on the wafer handlers of the transport mechanism 31. If interruption of an acoustic signal path is not detected at a time when a wafer is supposed to be present in the acoustic signal path, then appropriate steps are taken, such as interrupting the processing of the wafers, setting off an alarm, etc.

Because the transmitter/receiver pairs are disposed above the cleaning/drying modules 15-21, liquid that may be present inside the modules does not interfere with operation of the sensor pairs. The layout of the sensor signal paths S, as shown in FIG. 2, is such that the various sensor pairs do not interfere with each other, so that reliable detection of the wafers can be carried out. Moreover, because acoustic sensors are used, it is possible to reliably detect the presence of transparent wafers such as quartz wafers, which are substantially opaque to the light wave signals utilized by optical sensors.

The present invention is shown as being applied with respect to a wafer cleaning system made up of four modules, namely a megasonic cleaner, two scrubbers and a spin-rinse-dryer. However, it is also contemplated to apply the present invention to wafer cleaning systems having more or fewer than four cleaning and/or drying modules, and also to wafer cleaning systems having a line-up of cleaning and/or drying modules that is different from the megasonic cleaner/scrubber/scrubber/spin-rinse-dryer line-up of the exemplary cleaning system described above. Furthermore, it is contemplated that the sensor arrangements of the present invention may be applied to polishers and to other semiconductor processing systems in addition to cleaning systems.

Still further, the arrangement of sensor signal paths shown herein may be applied with respect to sensors other than acoustic sensors. Thus, the signal path arrangement shown in FIG. 2 could be implemented with optical sensors. It is also contemplated to use optical sensors or other types of sensors besides acoustic sensors to provide sensor signal paths that are mounted above chambers of cleaning and/or drying modules or other modules for processing substrates.

Although the orientation of the wafers has been described as vertical, and the locus of raising or lowering the wafers has also been described as defining a vertical plane, it is contemplated that the exact orientation of the wafers and/or the direction of raising or lowering may vary by a few degrees from vertical.

According to FIG. 1, the acoustic transmitters and acoustic receivers are shown as being mounted a short distance above the processing modules. However, it is also contemplated that the acoustic transmitters and acoustic receivers may be mounted a considerable distance, say several inches or more, above the processing modules.

The foregoing description discloses only the preferred embodiments of the invention; modifications of the above disclosed apparatus and methods which fall within the scope of the invention will be readily apparent to those of ordinary skill in the art. Particularly, although the arrangement shown in FIGS. 1 and 2 is preferred, it will be understood that, in one aspect, the invention is generally directed to the positioning of a substrate within an acoustic signal path such that the substrate breaks the signal path, and to apparatuses that that operate in accordance therewith, regardless of the process performed on the substrate, or of the number or orientation of chambers.

Accordingly, while the present invention has been disclosed in connection with the preferred embodiments thereof, it should be understood that other embodiments may fall within the spirit and scope of the invention, as defined by the following claims.

The invention claimed is:

1. A method of detecting the presence of a substrate, comprising:
positioning an acoustic transmitter and an acoustic receiver to define a path for travel of an acoustic signal from the acoustic transmitter to the acoustic receiver; and
using the acoustic receiver to detect the presence of a substrate between the acoustic transmitter and the acoustic receiver resulting in the interruption of the acoustic signal.

2. The method of claim 1, wherein the acoustic transmitter and the acoustic receiver are positioned above a chamber adapted to process the substrate.

3. The method of claim 2, wherein the chamber is adapted to clean and/or dry the substrate.

4. The method of claim 2, wherein the path defined by the acoustic transmitter and the acoustic receiver forms an acute angle with a plane in which the substrate is raised from the chamber in a vertical orientation.

5. A method of detecting the presence of a substrate, comprising:
positioning a transmitter and a receiver above a chamber to define a path for travel of a detection signal from the transmitter to the receiver, the chamber being adapted to process a substrate;
using the receiver to detect the presence of a substrate between the transmitter and the receiver resulting in the interruption of the detection signal.

6. The method of claim 5, wherein the detection signal is an acoustic signal, the transmitter is an acoustic transmitter, and the receiver is an acoustic receiver.

7. The method of claim 5, wherein the chamber is adapted to clean and/or dry the substrate.

8. The method of claim 5, wherein the path defined by the transmitter and the receiver forms an acute angle with a plane in which the substrate is raised from the chamber in a vertical orientation.

9. A method of detecting the presence of substrates, comprising:
providing a linear array of chambers adapted to clean and/or dry substrates;
providing a transport mechanism adapted to lower the substrates into and to raise the substrates from the chambers, the substrates being raised and lowered while held in a vertical orientation, the raising and lowering of a respective substrate with respect to each chamber defining a respective vertical plane;
using respective acoustic transmitter/receiver pairs to define a plurality of acoustic signal paths, each of the acoustic signal paths intersecting a respective one of the vertical planes at an acute angle; and
detecting the presence of the substrates by detecting interruption of the acoustic signal paths.

10. The method of claim 9, wherein the transport mechanism includes a walking beam robot.

11. The method of claim 9, wherein the acoustic signal paths are substantially parallel to each other.

12. A substrate detection apparatus, comprising:
a linear array of chambers adapted to clean and/or dry substrates;
a transport mechanism adapted to lower the substrates into and to raise the substrates from the chambers, the transport mechanism raising and lowering the substrates while holding the substrates in a vertical orientation, the raising and lowering of a respective substrate with respect to each chamber defining a respective vertical plane; and
a plurality of transmitter/receiver pairs each adapted to define respective signal paths, each of the signal paths intersecting a respective one of the vertical planes at an acute angle.

13. The substrate detection apparatus of claim 12, wherein the transport mechanism includes a walking beam robot.

14. The substrate detection apparatus of claim 12, wherein the linear array of chambers includes four chambers.

15. The substrate detection apparatus of claim 12, wherein the transmitter/receiver pairs are mounted above the linear array of chambers.

16. The substrate detection apparatus of claim 12 wherein the transmitter/receiver pairs are acoustic transmitters and receivers.

17. The substrate detection apparatus of claim 15 wherein the transmitter/receiver pairs are acoustic transmitters and receivers.

18. The substrate detection apparatus of claim 12, wherein each transmitter/receiver pair is associated with a respective one of the chambers, the transmitter associated with a first one of the chambers transmits a signal in a first direction, and the transmitter associated with a second one of the chambers transmits a signal in a second direction that is opposite to the first direction.

19. The substrate detection apparatus of claim 18, wherein the second one of the chambers is adjacent the first one of the chambers.

20. A processing apparatus, comprising:
a chamber adapted to process a substrate; and
an acoustic transmitter and an acoustic receiver positioned to define a path for travel of an acoustic signal from the acoustic transmitter to the acoustic receiver, the acoustic transmitter and acoustic receiver being mounted above the chamber.
